(19) United States
(12) Patent Application Publication
(10) Pub. No.: US 2022/0274393 A1
(43) Pub. Date: Sep. 1, 2022

(54) METHOD FOR TRANSFERRING AND/OR FIXATING A PRINT ON(TO) A SUBSTRATE IN A DEVICE FOR TRANSFER AND/OR FIXATION

(71) Applicant: ING. GERRITSE HOLDING B.V., Brummen (NL)

(72) Inventor: Jan GERRITSE, Brummen (NL)

(73) Assignee: ING. GERRITSE HOLDING B.V., Brummen (NL)

(21) Appl. No.: 17/632,001

(22) PCT Filed: Jul. 31, 2020
(86) PCT No.: PCT/NL2020/050491

§ 371 Date: Feb. 1, 2022

(30) Foreign Application Priority Data
Aug. 1, 2019 (NL) 2023597
Sep. 19, 2019 (NL) 2023858

(51) Int. Cl. B41F 16/00; B41F 13/56; B41F 33/00

(52) U.S. Cl. CPC B41F 16/0026; B41F 13/56; B41F 33/0036

(57) ABSTRACT

A method for transferring and/or fixating a print on(to) a substrate includes feeding a substrate through a device for transfer and/or fixation for the purpose of transferring thereto and/or fixating thereon a print, where the substrate has been provided or is provided with a number of basic colours and optional dilutions thereof, comparing the basic colours and the optional dilutions thereof of the substrate to registered verification basic colours and optional dilutions thereof, and approving or not approving the substrate on the basis thereof, and/or comparing basic colours and optional dilutions thereof of a print paper, to be fed through with the substrate with a print to be transferred and said basic colours and optional dilutions thereof to registered print basic colours and optional dilutions thereof, and approving or not approving the print paper on the basis thereof.

The invention relates to a method for transferring and/or fixating a print on(to) a substrate in a device for transfer and/or fixation.

Such a method is per se known. According to the known method, a substrate is fed through a device for transfer and/or fixation, wherein a print is fixated on the substrate if the substrate already had a print printed thereon prior to throughfeed through the device for transfer and/or fixation, or is transferred thereto from a so-called transfer paper if the substrate did not yet have a print prior to throughfeed through the device for transfer and/or fixation. The device for transfer and/or fixation is also referred to in the field as a calender. The substrate can be any desired and/or suitable substrate, such as for instance textile. The transferring and/or fixating of the print takes place under the influence of heat.

It is desirable for each substrate to be consistent, with a non-varying print. The print may however aberrate due to different causes.

It is an object of the invention to at least reduce or preferably obviate this drawback.

This object can be achieved with a method of the type stated in the preamble, which comprises according to the invention the following step of:

a) feeding a substrate through a device for transfer and/or fixation for the purpose of transferring thereto and/or fixating thereon a print, wherein the substrate has been provided or is provided with a number of basic colours and optional dilutions thereof;

and at least one of the following steps of:

b) comparing the basic colours and the optional dilutions thereof of the substrate to registered verification basic colours and optional dilutions thereof before and/or after step a), and approving or not approving the substrate on the basis thereof, and

c) comparing basic colours and optional dilutions thereof of a print paper, to be fed through with the substrate in step a), with a print to be transferred and said basic colours and optional dilutions thereof to registered print basic colours and optional dilutions thereof before step a), and approving or not approving the print paper on the basis thereof.

According to an aspect of the invention, the basic colours and the optional dilutions thereof of the substrate are compared prior to and/or after throughfeed through the device for transfer and/or fixation to registered verification basic colours and optional dilutions thereof. This comparison enables variations from the registered verification basic colours and optional dilutions thereof, and thereby variations of the print on the substrate which is yet to be fixated and/or has already been transferred and/or fixated, to be found, making it possible to approve or reject the substrate.

Alternatively or additionally, and if the print is transferred from a print paper, i.e. the above stated transfer paper, to the substrate during throughfeed through the device for transfer and/or fixation, it is possible to compare the basic colours and optional dilutions thereof of the print paper to registered print basic colours and optional dilutions prior to throughfeed through the device for transfer and/or fixation. This comparison enables variations from the registered print basic colours and optional dilutions thereof, and thereby variations of the print on the print paper, to be found, making it possible to approve or reject the print paper.

Timely rejection of the substrate and/or print paper can for instance prevent a substrate with an aberrant print being sent to a customer or user, or can preferably prevent the substrate and/or the print paper from being fed through the device for transfer and/or fixation, or from being fed further through the device for transfer and/or fixation at a certain moment in the transfer and/or fixation process, at least without implementing adjustments to for instance the settings of the device for transfer and/or fixation.

It has been found by applicant that it is relatively simple to compare the basic colours and optional dilutions thereof, and not for instance the complex print itself. A possible variation in the basic colours and optional dilutions thereof indicates a variation in the print. It will be apparent here to the skilled person that these basic colours can be provided in the form of one or more than one zone, preferably extending on the paper in two dimensions and having a uniform or homogenous colour, i.e. the basic colour, wherein in the case of more than one zone at least the adjacent and preferably all zones have a different basic colour.

The basic colours can for instance comprise red, yellow and blue. These are examples of mixed colours, which can be obtained by mixing one or more than one of the primary colours cyan, magenta, yellow and black (CMYK), common in printed matter. The basic colours can however also be the primary colours themselves, without being mixed. The basic colours can therefore comprise primary colours and/or mixed colours. The optional dilutions thereof are these basic colours, each time with less colour. The basic colour comprises for instance 100% colour, and for instance three dilutions thereof respectively 80%, 60% and 40% colour.

It will be apparent to the skilled person that the stated comparison options can be performed before and/or after step a), and that any of and any desired number of said comparison options can be performed as desired. It is thus possible to assess only the substrate, and then only before or after throughfeed through the device for transfer and/or fixation, or both before and after throughfeed through the device for transfer and/or fixation. It is also possible to assess only the print paper before throughfeed through the device for transfer and/or fixation. Or both the print paper and the substrate can be assessed, wherein the print paper is assessed before throughfeed through the device for transfer and/or fixation, and wherein the substrate is for instance assessed only before or after throughfeed through the device for transfer and/or fixation or both before and after throughfeed through the device for transfer and/or fixation.

Criteria can be defined for approval or rejection of the substrate and/or print paper. It is thus possible for approval to take place if there is no variation whatsoever, but it is for instance also possible to determine a maximum permitted variation within which the substrate and/or print paper is approved.

In an embodiment of the method according to the invention the basic colours and optional dilutions thereof mentioned in step a) have been or are provided on an edge, such as a longitudinal edge, transverse edge and/or end edge, of the substrate and/or the basic colours and optional dilutions thereof mentioned in step c) are printed on an edge, such as a longitudinal edge, transverse edge and/or end edge, of the print paper.

Applying basic colours and optional dilutions thereof in the edge has the advantage that these basic colours and optional dilutions thereof can be detected and thereby verified in simpler manner. The basic colours and optional dilutions thereof are therefore more particularly preferably placed at a distance from the print itself.

Furthermore, they can be cut away more easily after the verification of the transfer and/or fixation without having an adverse effect on the (actually intended) print. For this reason the method therefore preferably comprises the step g) of cutting away the edge of the substrate and/or the print paper with the basic colours and optional dilutions thereof after step a) and at least one of the steps b) and c).

According to the invention, it is possible to verify the substrate and/or the print paper once and to approve or reject it therein. It can however be preferred to perform step b) and/or step c) in-line and/or to periodically repeat step b) and/or step c). Possible variations of the print on the substrate and/or print paper can hereby be found in timely manner and, if desired, an intervention can be made in the process and/or after every comparison in timely manner, for instance by an operator or automatically.

During throughfeed through the device for transfer and/or fixation one or more of said comparisons can for instance be performed every second or every few seconds, or alternatively every metre or every few metres. Step b) and/or c) can more particularly be repeated multiple times per substrate and/or print paper.

When the respective substrate and/or print paper is not approved in respectively step b) and/or step c), at least one of the following steps can be performed:

d) stopping the device for transfer and/or fixation at least temporarily, and

e) adjusting at least one setting of the device for transfer and/or fixation.

At least temporarily stopping the device for transfer and/or fixation makes it possible to prevent the substrate and/or print paper from being fed through (further) and therefore having to be rejected over a greater length and/or unnecessary process time and/or energy from being used for a rejected substrate and/or print paper. Stopping the device for transfer and/or fixation can for instance be opted for if it is expected that the variation cannot be resolved quickly.

Variations can for instance possibly be caused by the device for transfer and/or fixation. By adjusting the setting(s) of the device for transfer and/or fixation after a variation has been ascertained it is possible to resolve the possible variations. Adjusting of the setting(s) can take place both during the process, wherein the device for transfer and/or fixation is not stopped and the throughfeed of the substrate and/or print paper is continued, or during an at least temporary stopping of the device for transfer and/or fixation. Not stopping the device for transfer and/or fixation can for instance be an option when the variation is small, for instance smaller than a maximum permitted variation, and it is expected that the variation will decrease by adjusting the setting(s). Alternatively or additionally, not stopping the device for transfer and/or fixation can for instance be an option when it is expected that adjusting of the setting(s) can take place quickly and/or will have a quick effect.

It is for instance also possible that it is first attempted to resolve the variation by performing step e) while the device for transfer and/or fixation is not stopped, and that the device for transfer and/or fixation is for instance also still stopped later by performing step d), for instance if it is found that the variation is not being resolved, or not quickly enough.

It has been found by applicant that at least one of the following settings can be adjusted:
a temperature of a roller of the device for transfer and/or fixation;
a transfer and/or fixation duration;
a pressure of a belt of the device for transfer and/or fixation.

The temperature of the roller can for instance be increased or reduced, for instance subject to an ascertained variation.

The transfer and/or fixation duration can for instance be increased or reduced, for instance subject to an ascertained variation. Increasing or reducing the duration can for instance be achieved by respectively reducing and increasing a throughfeed speed.

The pressure of the belt can for instance be increased or reduced, for instance subject to an ascertained variation. Increasing or reducing the pressure can printers be achieved by respectively tightening the belt and arranging the belt more loosely.

These settings are suitable parameters for influencing the transfer and/or fixation because it has been found by applicant that, depending on the belt pressure, contact time and/or temperature, the colour of the dyes used in such processes can change during said transfer and/or fixation processes as a result of sublimation.

In an embodiment of the method according to the invention the method comprises the step h) of detecting the at least one material property of at least one of the substrate and the print paper, such as the colour, wherein in step e) the adjustment of the at least one setting also takes place on the basis of the material property detected in step h).

It has been found that the nature of the substrate and/or the print paper can also contribute to the quality of transfer and/or fixation. A substrate and/or the print paper having determined colours, such as a relatively high optical white content, can thus for instance have an effect on quality. For this reason it is recommended also to consider the substrate and/or the print paper, irrespective of prints which may or may not be applied thereto, in determining the settings, this in addition to the above described verification of the print on substrate and/or print paper.

When the basic colours and optional dilutions thereof are applied to the substrate and/or the print paper in an edge, such as an end edge, it is therefore preferred that also provided adjacently of the basic colours on this edge, for instance in line with these colours, is a zone in which the substrate and/or print paper is left unprinted in order to be able to detect at least one material property thereof, particularly the colour thereof, without a print.

It is elucidated above that the print paper can be verified before step a). Additionally or alternatively, it is possible to perform the following step f) of: after step a), comparing the basic colours and the optional dilutions thereof of the print paper, fed through with the substrate in step a), to registered residual print basic colours and optional dilutions thereof.

When a print is transferred from a print paper to the substrate, residues remain on the print paper. By comparing the residues of basic colours and optional dilutions thereof to registered residual print basic colours and optional dilutions thereof it is possible to determine whether a transfer from the print paper to the substrate has taken place correctly. If for instance too much or too little of the basic colours and optional dilutions thereof remains on the print paper, this is an indication that the print on the substrate will aberrate.

The method(s) according to claims 5 and/or 6 can additionally or alternatively be performed when a variation between the basic colours and optional dilutions thereof and the registered residual print basic colours and optional dilutions thereof is found in step f).

The registered verification and/or print and/or residual print basic colours and optional dilutions thereof can for instance be obtained by registering the basic colours and optional dilutions thereof of a verification substrate and/or verification print paper, before and/or after throughfeed through the device for transfer and/or fixation.

In other words, in this embodiment of the method a print paper and/or substrate with a satisfactory print is chosen as respectively verification print paper or verification substrate, and the basic colours and optional dilutions thereof printed thereon are registered as registered verification and/or print and/or residual print basic colours. The basic colours and optional dilutions thereof of other substrates and/or print papers can then be compared to this registered verification and/or print and/or residual print basic colours, and be approved or rejected on the basis thereof.

The verification substrate and/or verification print paper can respectively also be referred to as mother substrate and/or mother print paper.

It is noted, as will also be apparent from the description of the invention above, that the verification basic colours are the basic colours of the verification substrate, before and/or after step a) is performed, that the print basic colours are the basic colours of the optionally provided verification print paper before step a) is performed, and that the residual print basic colours are the basic colours of the optionally provided verification print paper after step a) is performed.

It is further noted that, if desired, the basic colours of the verification substrate which are registered before step a) is performed can be designated as verification basic colours-before and that, if desired, the basic colours of the verification substrate which are registered after step a) is performed can be designated as verification basic colours-after.

It is further noted, as will also be apparent from the description of the invention above, that the basic colours of a substrate are compared to the registered verification basic colours-before and/or verification basic colours-after, depending on whether the comparison takes place respectively before or after step a), and that the basic colours of a print paper are compared to the registered print basic colours and/or residual print basic colours, depending on whether the comparison takes place respectively before or after step a).

Finally, it is noted that reference is not always made above to “the optional dilutions” of the basic colours for the sake of clarity, but that they can of course also optionally be compared, as elucidated above.

In yet another embodiment of the method according to the invention at least one of the steps b), c), f) and h) can be performed by capturing the basic colours and optional dilutions thereof stated therein with at least one camera or spectrophotometer, and comparing the captured basic colours and optional dilutions thereof to corresponding registered verification and/or print and/or residual print basic colours and optional dilutions thereof.

In other words, viewing the basic colours and optional dilutions thereof takes place automatically using at least one camera or spectrophotometer, and the basic colours and optional dilutions thereof captured thereby can be automatically compared to the corresponding registered verification and/or print and/or residual print basic colours and optional dilutions thereof.

An advantage of such a method is that comparing need not be done by a person, which can save costs and/or can increase accuracy.

Comparing the captured basic colours and optional dilutions thereof to corresponding registered verification and/or print and/or residual print basic colours and optional dilutions thereof can for instance be performed by a computer.

All captured basic colours and optional dilutions thereof can preferably be stored in a database. The database can here optionally be coupled wirelessly to the at least one camera or spectrophotometer.

In practical manner, origin data, for instance a project number and/or colourway number and/or date, can further be printed and/or transferred and/or fixated, for instance in an edge of the (verification) print paper and/or (verification) substrate. The invention further relates to a system for use in a method as described above on the basis of one of more of the described examples and/or embodiments and/or with one or more of the above described features, alone or in any random combination, comprising at least one camera or spectrophotometer for capturing determined basic colours and optional dilutions thereof, and a computer configured to run a computer program in which the captured basic colours and optional dilutions thereof are compared to corresponding registered verification and/or print and/or residual print basic colours and optional dilutions thereof.

It will be apparent to the skilled person that the advantages and/or elucidations described on the basis of the method likewise apply to the system according to the invention.

The system according to the invention can comprise any desired number of cameras and/or spectrophotometers, for instance in accordance with which basic colours and optional dilutions thereof will be captured. One camera and/or spectrophotometer can for instance be provided, which captures the basic colours and optional dilutions thereof of the substrate and/or print paper before throughfeed through the device for transfer and/or fixation and/or one camera and/or spectrophotometer which captures the basic colours and optional dilutions thereof of the substrate and/or print paper after throughfeed through the device for transfer and/or fixation. Separate cameras and/or spectrophotometers can also be provided for the print paper and substrate.

The at least one camera or spectrophotometer and the computer can optionally be connected or connectable wirelessly to each other.

In an embodiment of the system according to the invention the system comprises a database in which at least one of the following data is stored:
the captured basic colours and optional dilutions thereof;
the registered verification, print or residual print basic colours and optional dilutions thereof;
origin data;
at least one setting of the device for transfer and/or fixation;
measured device data and possible variations between measured and set data, and
possible variations from production data.

By storing one or more of said data the method according to the invention can be performed properly and/or quickly and/or accurately.

Storing the registered verification, print or residual print basic colours and optional dilutions thereof in the database thus for instance enables one or more of the described comparisons to be carried out.

Storing the at least one setting of the device for transfer and/or fixation for instance makes it possible to repeat historical settings for new productions.

The device for transfer and/or fixation can be set in a determined manner, but the actual specifications may differ. The roller can thus be set to a determined temperature, but the actual temperature can turn out higher or lower, which can for instance also apply to the pressure of the belt. By likewise storing these measured data, and possible variations from the set data, in the database previous productions can be repeated better and/or errors can be discovered.

It is possible that a customer desires different settings, for instance a dark print. These possible variations can likewise be stored.

It will be apparent that, if desired, other data can also be stored in the system.

The at least one camera or spectrophotometer and the database and the computer can optionally be connected or connectable wirelessly to each other, for instance via a computer network such as for instance the Internet.

The system according to the invention can also comprise a stated device for transfer and/or fixation.

The at least one camera or spectrophotometer can be disposed upstream and/or downstream of the device for transfer and/or fixation.

The device for transfer and/or fixation can optionally be connected or connectable wirelessly to the database and/or the computer, for instance via a computer network, such as for instance the Internet. This has the advantage that the data as collected, if desired of a plurality of devices for transfer and/or fixation, can be collected in one database. Central processing of these data in one database can provide the advantage that these data can be secured more easily and thereby more cheaply. Wireless connections are preferred here because they are very flexible and have sufficient bandwidth for the amount of data to be transferred.

Upstream and downstream are defined here in a throughfeed direction of the device for transfer and/or fixation.

One or more cameras or spectrophotometers can for instance be disposed above an infeed of the device for transfer and/or fixation.

One or more cameras or spectrophotometers can for instance be disposed above an outfeed of the device for transfer and/or fixation.

The invention will be further elucidated with reference to the accompanying figures, in which:

FIG. 1 shows schematically a system according to a first embodiment of the invention;

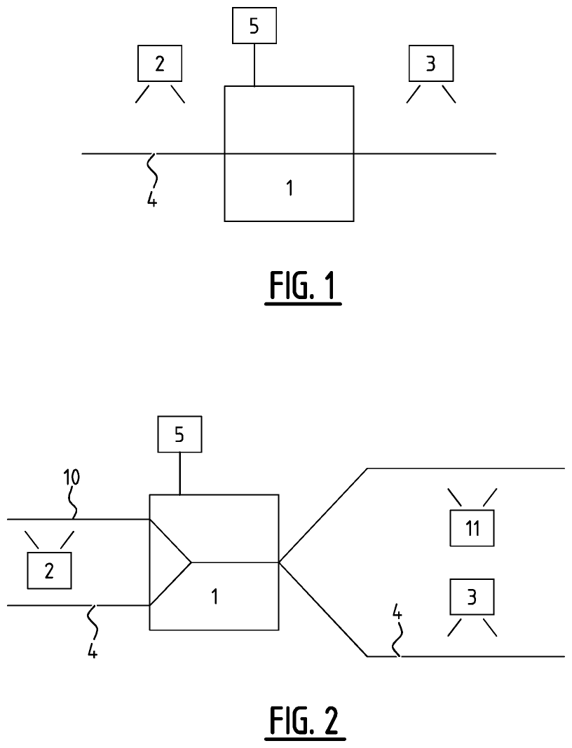

FIG. 2 shows schematically a system according to a second embodiment of the invention; and

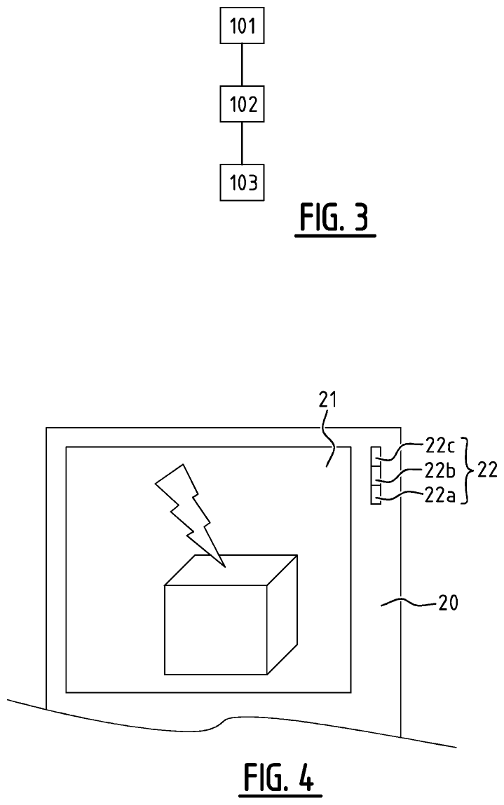

FIG. 3 shows schematically the steps of a method according to a first embodiment of the invention.

FIG. 4 shows schematically a print on a substrate according to a method according to the invention.

The same elements are designated in the figures with the same reference numerals.

FIG. 1 shows in highly simplified and schematic manner a system according to a first embodiment of the invention. The system comprises a device for transfer and/or fixation 1, such as for instance a calender. Disposed in this case in the vicinity of respectively an infeed and outfeed of the device for transfer and/or fixation 1 is respectively a first camera 2 and a second camera 3.

First camera 2 is pointed at a substrate 4. Substrate 4 comprises a print applied thereto and a number of basic colours and dilutions thereof which are applied to an edge of substrate 4. The edge with the basic colours and dilutions thereof can for instance be one of the two longitudinal edges, which longitudinal edge can for instance be cut away if so desired. The print and the basic colours and dilutions thereof are applied to a side of substrate 4 directed toward first camera 2. The print and the basic colours and dilutions thereof can for instance be printed on substrate 4 by printing. The print and the basic colours and dilutions thereof are fixated on substrate 4 in the device for transfer and/or fixation 1. The first camera 2 captures the basic colours and dilutions thereof of substrate 4 prior to throughfeed of substrate 4 through the device for transfer and/or fixation 1. The basic colours and dilutions thereof captured by first camera 2 are compared to registered verification basic colours-before and dilutions thereof. If no variation is found between the captured basic colours and dilutions thereof and the registered verification basic colours-before and dilutions thereof, or if a possible variation is smaller than a maximum permitted variation, substrate 4 can be approved and the process can be continued uninterrupted. If a variation is found between the captured basic colours and dilutions thereof and the registered verification basic colours-before and dilutions thereof, or if a possible variation is greater than a maximum permitted variation, substrate 4 cannot be approved. If substrate 4 is not approved at the start of or during the process, it can be decided to respectively not feed this rejected substrate 4 through the device for transfer and/or fixation 1 or not feed it through any further.

Second camera 3 is likewise pointed at substrate 4 and captures the basic colours and dilutions thereof of substrate 4 after throughfeed of substrate 4 through the device for transfer and/or fixation 1. In other words, second camera 3 captures the fixated basic colours and dilutions thereof of substrate 4. The basic colours and dilutions thereof captured by second camera 3 are compared to registered verification basic colours-after and dilutions thereof. If no variation is found between the captured basic colours and dilutions thereof and the registered verification basic colours-after and dilutions thereof, or if a possible variation is smaller than a maximum permitted variation, substrate 4 can be approved and the process can be continued uninterrupted. If a variation is found between the captured basic colours and dilutions thereof and the registered verification basic colours-after and dilutions thereof, or if a possible variation is greater than a maximum permitted variation, substrate 4 cannot be approved. If substrate 4 is not approved, a setting of the device for transfer and/or fixation 1 can for instance be adjusted, such as for instance a temperature of a roller of the device for transfer and/or fixation and/or a transfer and/or fixation duration and/or a pressure of a belt of the device for transfer and/or fixation. If it is expected that the variation cannot be solved quickly, the device for transfer and/or fixation 1 can be stopped at least temporarily. Adjusting the at least one setting and/or stopping the device for transfer and/or fixation 1 can for instance be carried out by an operator or automatically.

As shown in FIG. 1, the system further comprises a database 5. Any desired type of data is stored in database 5, which data can for instance be used for setting the device for transfer and/or fixation 1 and/or for carrying out the described comparisons.

In this embodiment first camera 2 and second camera 3 are disposed in-line in the process and are preferably configured to capture the basic colours and dilutions thereof periodically, for instance every second, wherein a comparison can also take place each time. Regularly capturing and comparing the basic colours and dilutions thereof enables rapid intervention if a variation is ascertained. Wastage of substrate and/or energy can in this way be prevented or at least limited as far as possible.

FIG. 2 shows in highly simplified and schematic manner a system according to a second embodiment of the invention. Only the differences with the system of FIG. 1 will be described here. For a further description of the system reference is made to the description associated with FIG. 1.

The system according to the second embodiment comprises a first camera 2 which is here also disposed in the vicinity of the infeed of the device for transfer and/or fixation 1, but which is here pointed at a print paper 10. Print paper 10 comprises a print applied thereto, and a number of basic colours and dilutions thereof which are applied to an edge of the print paper 10. The edge with the basic colours and dilutions thereof can for instance be one of the two longitudinal edges. The print and the basic colours and dilutions thereof are applied to a side of print paper 10 directed toward first camera 2. The print and the basic colours and dilutions thereof can for instance be printed on print paper 10 by printing. The print and the basic colours and dilutions thereof are transferred to and fixated on substrate 4 in the device for transfer and/or fixation 1. The basic colours and dilutions thereof captured by first camera 2 are compared to registered print basic colours and dilutions thereof. If no variation is found between the captured basic colours and dilutions thereof and the registered print basic colours and dilutions thereof, or if a possible variation is smaller than a maximum permitted variation, print paper 10 can be approved and the process can be continued uninterrupted. If a variation is found between the captured basic colours and dilutions thereof and the registered print basic colours and dilutions thereof, or if a possible variation is greater than a maximum permitted variation, print paper 10 cannot be approved. If print paper 10 is not approved, it can for instance be decided not to feed this rejected print paper 10 through the device for transfer and/or fixation 1, or not to feed it through any further.

The system according to the second embodiment further comprises a second camera 3 which is here also disposed in the vicinity of the outfeed of the device for transfer and/or fixation 1, and which is here also pointed at substrate 4. The second camera captures the basic colours and dilutions thereof of substrate 4 after throughfeed of substrate 4 through the device for transfer and/or fixation 1, just as in the first embodiment, and the further comparison which is carried out is also the same as that of the first embodiment, for which reason it will not be further elucidated here but the above stated reference will suffice.

The system according to the second embodiment further comprises a third camera 1 which is disposed in the vicinity of the outfeed of the device for transfer and/or fixation 1 and which is pointed at print paper 10. Third camera 11 captures the residues of the basic colours and dilutions thereof of print paper 10 after throughfeed of print paper 10 through the device for transfer and/or fixation 1. The residues of basic colours and dilutions thereof captured by third camera 11 are compared to registered residual print basic colours and dilutions thereof. If no variation is found between the captured basic colours and dilutions thereof and the registered residual print basic colours and dilutions thereof, or if a possible variation is smaller than a maximum permitted variation, the print paper 10 used can be approved and the process can be continued uninterrupted because this is an indication that the transfer from print paper 10 has taken place properly. If a variation is found between the captured residues of basic colours and dilutions thereof and the registered residual print basic colours and dilutions thereof, or if a possible variation is greater than a maximum permitted variation, the print paper 10 used cannot be approved because this is an indication that the transfer to substrate 4 has not taken place properly. If print paper 10 is not approved, a setting of the device for transfer and/or fixation 1 can for instance be adjusted, such as for instance a temperature of a roller of the device for transfer and/or fixation and/or a transfer and/or fixation duration and/or a pressure of a belt of the device for transfer and/or fixation. If it is expected that the variation cannot be solved quickly, the device for transfer and/or fixation 1 can be stopped at least temporarily. Adjusting the at least one setting and/or stopping the device for transfer and/or fixation 1 can for instance be carried out by an operator or automatically.

FIG. 3 shows an exemplary embodiment of a method according to the invention. In this embodiment the method comprises a first step 101 of comparing basic colours and the optional dilutions thereof of a substrate to registered verification basic colours-before and optional dilutions thereof, and approving or not approving the substrate on the basis thereof. If the substrate is approved, a second step 102 can be performed and/or continued, which second step 102 comprises of feeding the substrate through a device for transfer and/or fixation for the purpose of transferring thereto and/or fixating thereon a print. In a third step 103 the basic colours and the optional dilutions thereof of the substrate after throughfeed through the device for transfer and/or fixation are compared to registered verification basic colours-after and optional dilutions thereof, and the substrate is approved or is not approved on the basis thereof. As soon as a possible variation in the basic colours and dilutions thereof is ascertained in step 101 and/or step 103, step 102 can if desired be stopped temporarily, or at least one setting of the device for transfer and/or fixation can be adjusted while step 102 is or is not continued.

It will be apparent to the skilled person that the method according to FIG. 3 can comprise any desired alternative or additional step. It can thus alternatively be the case in step 101 that the basic colours and optional dilutions thereof of a print paper are compared to registered print basic colours and optional dilutions thereof. Alternatively or additionally to step 103, it can be the case that the basic colours and optional dilutions thereof of a print paper used are compared to registered residual print basic colours and optional dilutions thereof.

FIG. 4 shows a schematic configuration of a print as can be applied to a substrate. Substrate 20 is provided with a complex print 21, in this case represented as an image of a bordered cube with a lightning bolt, although in practice it can take any form, and in practice the border can be absent. Printed in the edge of substrate 20, at a distance from print 21, are a number of surfaces 22a, 22b and 22c having a different basic colour, which can be compared to verification basic colours in the method according to the invention. It will be apparent that, in the case that the method is applied for transfer, the print paper can be provided with a similar configuration.

It will be apparent to the skilled person that the substrate described in the foregoing can for instance be a final or intermediate product, but that the substrate can also be a trial print prior to making a final or intermediate product. In that case a portion of the print paper and/or substrate intended for the final or intermediate product can for this purpose be cut off for the purpose of the method.

Although the invention is elucidated above on the basis of a number of specific examples and embodiments, the invention is not limited thereto. The invention instead also covers the subject matter defined by the following claims.

1. A method for transferring and/or fixating a print on(to) a substrate in a device for transfer and/or fixation, comprising:
a) feeding a substrate through a device for transfer and/or fixation for the purpose of transferring thereto and/or fixating thereon a print, wherein the substrate has been provided or is provided with a number of basic colours and dilutions thereof;
and at least one of:
b) comparing the basic colours and the dilutions thereof of the substrate to registered verification basic colours and dilutions thereof before and/or after step a), and approving or not approving the substrate on the basis thereof, and
c) comparing basic colours and dilutions thereof of a print paper, to be fed through with the substrate in step a), with a print to be transferred and said basic colours and dilutions thereof to registered print basic colours and dilutions thereof before step a), and approving or not approving the print paper on the basis thereof.

2. The method according to claim 1, wherein the basic colours and dilutions thereof in step a) have been or are provided on an edge, such as a longitudinal edge, transverse edge and/or end edge, of the substrate and/or wherein the basic colours and dilutions thereof in step c) are printed on an edge, such as a longitudinal edge, transverse edge and/or end edge, of the print paper.

3. The method according to claim 2, comprising the step g) of cutting away the edge of the substrate and/or the print paper with the basic colours and dilutions thereof after step a) and at least one of the steps b) and c).

4. The method according to claim 1, wherein step b) and/or step c) is performed in-line and/or repeated periodically.

5. The method according to claim 1, wherein, if the respective substrate and/or print paper is not approved in respectively step b) and/or step c), at least one of the following steps is performed:
d) stopping the device for transfer and/or fixation at least temporarily, and
e) adjusting at least one setting of the device for transfer and/or fixation.

6. The method according to claim 5, wherein at least one of the following settings is adjusted in step e):
a temperature of a roller of the device for transfer and/or fixation;
a transfer and/or fixation duration;
a pressure of a belt of the device for transfer and/or fixation.

7. The method according to claim 5, comprising the step h) of detecting at least one material property of at least one of the substrate and the print paper, such as the colour, wherein in step e) the adjustment of the at least one setting also takes place on the basis of the colour detected in step h).

8. The method according to claim 1, comprising the step, if applicable, of:
f) comparing the basic colours and the optional dilutions thereof of the print paper, fed through with the substrate in step a), to registered residual print basic colours and dilutions thereof after step a).

9. The method according to claim 1, wherein the registered verification and/or print and/or residual print basic colours and dilutions thereof are obtained by registering the basic colours and dilutions thereof of a verification substrate and/or verification print paper, before and/or after throughfeed through the device for transfer and/or fixation.

10. The method according to claim 1, wherein at least one of the steps b), c), f) and h) is performed by capturing the basic colours and dilutions thereof stated therein with at least one camera or spectrophotometer, and comparing the captured basic colours and optional dilutions thereof to corresponding registered verification and/or print and/or residual print basic colours and dilutions thereof.

11. The method according to claim 10, wherein all captured basic colours and dilutions thereof are stored in a database.

12. The method according to claim 1, wherein origin data, for instance a project number and/or colourway number and/or date, are further printed and/or transferred and/or fixated, for instance in an edge of the (verification) print paper and/or (verification) substrate.

13. A system for use in a method according to, claim 1, wherein at least one of the steps b), c), f) and h) is performed by capturing the basic colours and dilutions thereof stated therein with at least one camera or spectrophotometer, and comparing the captured basic colours and dilutions thereof to corresponding registered verification and/or print and/or residual print basic colours and dilutions thereof;
the system comprising at least one camera or spectrophotometer for capturing determined basic colours and dilutions thereof, and a computer configured to run a computer program in which the captured basic colours and dilutions thereof are compared to corresponding registered verification and/or print and/or residual print basic colours and dilutions thereof.

14. The system according to claim 13, comprising a database in which at least one of the following data is stored:
the captured basic colours and dilutions thereof;
the registered verification, print or residual print basic colours and dilutions thereof;
origin data;
at least one setting of the device for transfer and/or fixation;
measured machine data and possible variations between measured and set data, and
possible variations from production data.

15. The system according to claim 13, comprising a stated device for transfer and/or fixation.

16. The system according to claim 15, wherein the at least one camera or spectrophotometer is disposed upstream and/or downstream of the device for transfer and/or fixation.
